(19) United States
(12) Patent Application Publication
(10) Pub. No.: US 2017/0166782 A1
(43) Pub. Date: Jun. 15, 2017

(54) Polyurethane Release Agent

(71) Applicant: American Polymers Corporation, dba Polycoat Products, Santa Fe Springs, CA (US)

(72) Inventor: A. Andrew SHORES, Venice, CA (US)

(21) Appl. No.: 14/963,840

(22) Filed: Dec. 9, 2015

(51) Int. Cl. C09J 7/02

(52) U.S. Cl. CPC C09J 7/0246; C09J 7/0282; C09J 2201/122; C09J 2201/606; C09J 2483/006

(57) ABSTRACT

The invention discloses a pressure sensitive adhesive tape coated with a release agent prepared from a diisocyanate, silicone carbinol and diol having alkyl groups wherein the sum of carbon atoms in the alkyl groups bonded to the alpha carbon atoms relative to a hydroxyl group is 5-15.

### BACKGROUND OF THE INVENTION

Field of the Invention

This invention discloses a toluene soluble polyurethane release agent for pressure sensitive adhesive tapes prepared from a diisocyanate, a hydroxyl functional silicone and an alkyl substituted diol.

Description of the Prior Art

A pressure-sensitive adhesive tape is generally manufactured and sold with the tape wound upon itself in convolutions to form a roll of some suitable length of tape. Consequently, when it is necessary to use the tape, it must be possible to unwind the desired length from the roll without excessive force or delaminating of the backing, offsetting of the adhesive, or the like, regardless of the time or conditions under which the tape has remained in roll form prior to use. For these reasons, a coating known as a release coat, or low adhesion backsize, is generally provided on the backside of the tape, i.e. the side opposite on which the adhesive is applied. Such a coat, compared to an uncoated backing member, as is its objective, offers relatively low adhesion to the adhesive and makes the unwinding of the tape roll moderately easy. The release agent is normally coated to a backing member, such as plastic film or paper, from a dilute solution and the diluent, either a solvent or water, is evaporated in an oven. The solvent used in the tape industry for dissolving the release agent is toluene since it is easily recoverable with the carbon black/superheated steam process and one of the least expensive industrial solvent. However, the use of polyurethane release agents are severely restricted since they are soluble only in polar solvents and insoluble in hydrocarbon solvents, such as toluene.

It has been known for many years now, as earlier indicated, that certain silicones (organosiloxane polymers), or formulations thereof, can be applied to the surface of paper, various films and other substrates to render the surface thereof adhesive (i.e., non-adherent) to sticky and tacky material. Exemplary of this prior art are U.S. Pat. Nos. 2,882,183; 3,050,411; 3,328,482; 3,518,325; 3,565,838; 3,671,484; and 3,823,025. Of these, U.S. Pat. No. 3,518,325 discloses that, optionally, an isocyanate having at least two isocyanate groups per molecule, or a reaction product of such an isocyanate with a polyhydroxy compound, can be included in the silicone composition.

There has also been developed organofunctional silicone fluids, e.g. silicone polycarbinols, which combine typical silicone properties, for example, release, with alcohol reactivity. The silicone polycarbinols can be chemically bonded into any system which is reactive toward alcohol to permanently impart desirable silicone properties to that system. Thus, there can be provided silicone modified polyesters, silicone modified sulfonate, silicone modified urethanes, silicone modified melamines, and silicone modified phenolics.

Moreover, it has been suggested heretofore to use a silicone release agent in combination with a film forming resin, e.g. melamine or urea formaldehyde resin. Such a mixture is disclosed in U.S. Pat. No. 3,061,567. Thus, it has been found with such a composition that the organic resin is apparently preferentially absorbed on the substrate surface on which the release composition is deposited. This allows the silicone to be concentrated on the surface, thereby making for better release. For a given release less silicone is needed. The ratio of organosiloxane to organic resin in the mixture, as disclosed by the patentee, is not critical and can vary over a wide range.

In U.S. Pat. No. 4,002,792 there is disclosed a release agent for adhesive tapes made from a mercapto and methoxy terminated silicone reacted with a diisocyanate. The resulting polythiourethane can be applied from a solvent solution to the backing member of an adhesive tape. The solvent is subsequently removed by heat and the polymer is allowed to crosslink through its methoxy groups with ambiant moisture to provide a release coating.

Dahlquist disclosed in U.S. Pat. No. 2,532,011 polyvinyloctadecyl carbamate (PVODC from hereon) synthesized from polyvinyl alcohol and octadecyl isocyanate. It is still widely used to release coat pressure sensitive adhesive tapes since it can be dissolved with heat and agitation at low concentrations in hydrocarbon solvents. However, it has poor solubility in toluene at ambient temperatures and tends to precipitate below 25° C. in a very dilute solution. Higher concentration of PVODC, such as 5-10%, require maintaining 35-50° C. or more. Consequently they cannot be shipped and stored in toluene solution without heating and maintaining at those temperatures. Therefore, the release agent PVODC must be precipitated from the mother solution it was synthesized from, dried, shipped to the tape manufacturer who must then redissolve it in toluene to coat on a tape backing member. Furthermore, the coating process must be maintained at higher temperatures by external heating at the coating head, increasing energy demand and causing fire and health hazards. In addition, if the temperature accidentally drops, the PVODC drops out of the solution and clogs the gravure metering roll or the Meyer bar used for coating. That results in reduced coating thickness or spotty coating of the backing. The resulting adhesive tape will be non-functional with too hard unwind properties including tearing on unwind, especially after aging.

U.S. Pat. No. 4,287,109 of Schlak et al., discloses an aqueous resin of a Silicone-Si—O—C-Polyester block copolymer. B.P. 1,128,642 of Keberle et al. and G.P. DE 37 30 780 A1 of Nagorski et al. disclose water base silicone-modified polyurethanes. Keberle suggests their use for impregnating and coating fabrics, leather, paper, glass, wood, laminates and foamed plastics for anti static finishes and hydrophobic coatings, and as binder, lubricant, mold release agent, cleaning agent, leveling agent and corrosion inhibitor. Nagorski suggests usage as coating for wood, metal, paper, synthetic fabric, flock and leather. EPA 0 342 826 of Higgins and its corresponding U.S. Pat. No. 5,082,704 disclose a silicone-modified polyurethane dispersion in water which may be used to fabricate a release liner for adhesives, most notably for asphalt roofing materials. My own inventions, U.S. Pat. Nos. 5,356,706 and 5,543,171, disclose processes for manufacturing aqueous release coatings for pressure sensitive adhesive tapes by reacting a silicone oligomer having 2-3 isocyanate-reactive groups and a diol having an acidic group with an excess polyisocyanate, and further reacting, in water, with a tertiary amine to form a salt and a primary or secondary polyamine to extend the prepolymer into a polymeric chain. U.S. Pat. No. 5,679,754 of Larson et al. disclose fluorinated polyurethanes with sulfonate groups as release agent dispersion in water. U.S. Pat. Nos. 5,750,630 and 6,072,019 of Sengupta disclose a “polyurethane polymer whose chain includes silicone-containing segments and whose polymer chain is end-capped with a single isocyanate-reactive silane group” and a 2.5-30 weight percent solution in water of the polyurethane.

### SUMMARY OF THE INVENTION

The present invention is directed to a composition and method for forming a pressure sensitive adhesive coated article. The pressure sensitive adhesive coated article is formed by providing a polyurethane from the reaction product of a mixture of: A. diisocyanate; B. silicon with one or two hydroxyl groups that are bonded through intermediate Si—C linkage to alkylene or alkyleneoxy groups; and C. diol with alkyl groups wherein the sum of carbon atoms in the alkyl groups bonded to the alpha carbon atoms relative to a hydroxyl group is 5-15. This is then followed by coating a substrate with the polyurethane in toluene solution and removal the toluene by heat. The substrate is then coated with a pressure sensitive adhesive. The coated product may be wound upon itself and slit to various width to form rolls of pressure sensitive adhesive rolls.

In method form, the present invention relates to a process of manufacturing a pressure sensitive adhesive coated substrate comprising the steps of combining: A. diisocyanate; B. silicone with one or two hydroxyl groups that are bonded through intermediate Si—C linkage to alkylene or alkyleneoxy groups; C. diol with alkyl groups wherein the sum of carbon atoms in the alkyl groups bonded to the alpha carbon atoms relative to a hydroxyl group is 5-15, and forming a polyurethane, where the polyurethane is in a solvent. This is then followed by coating a flexible substrate with the polyurethane in toluene and removing toluene by heat and coating the substrate with a pressure sensitive adhesive.

### DETAILED DESCRIPTION

As noted, the present disclosure relates to the formation of a polyurethane comprising the reaction product of a diisocyanate, a silicone with one or two hydroxyl groups where the hydroxyl groups are bonded through an intermediate Si—C linkage to alkylene or alkyleneoxy groups, and an alkyl substituted diol. The polyurethane so formed is soluble in toluene and finds particular use for coating applications, such as a release agent for flexible pressure sensitive adhesive tapes. Reference to a flexible pressure sensitive adhesive tape is reference to a tape that is capable of flexing and bending at room temperature without failure.

One of the polyurethane component is a diol with alkyl groups. The sum of carbon atoms in the alkyl groups that are adjacent to the carbon atoms attached to a hydroxyl group is 5-15. Preferably, sum of the of carbon atoms in the alkyl groups in the carbon atoms adjacent to a hydroxyl group is 6-9. The total number of carbon atoms in the diol may be 8-16 or more. Examples of diols are 2-butyl-2-ethyl-1,3-propane diol, BEPD from hereon, 2-methyl-2-octyl-1,3-propanediol, 2-ethyl-2-propyl-1,3-hexanediol, EPHD from hereon, 2-methyl-2-hexyl-3-ethyl-3-butyl-1,4-butanediol, 2-ethyl-2-propyl-4-ethyl-4-propyl-1,3-pentanediol, and 2-hexyl-2-methyl-5-propyl-5-ethyl-1,6-hexanediol. By way of example, BEPD would have the following structure:

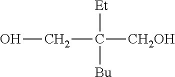

As can be seen from the above, when utilizing BEPD, the butyl and ethyl groups each represent an alkyl group, and as can be seen, in the case of the butyl group, it is on a carbon atom that is adjacent to a carbon atom having a hydroxyl group. Similarly, in the case of the ethyl group, it is also on a carbon atom that is adjacent a carbon atom having a hydroxyl group. Accordingly, the diol contains an alkyl substituted carbon atom adjacent to the carbons bearing the hydroxyl groups, wherein the sum of the carbon atoms in the alkyl groups is 6 and the total number of carbon atoms in the diol is 9.

As the polyurethane herein may be formed by various combinations of the diisocyanate compound, the silicon compound and the alkyl substituted diol, it can be appreciated by those of skill in the art, as discussed more fully herein, that many different repeating unit sequences may occur in the final polyurethane polymer. However, it can be appreciated that the reaction of a diisocyanate with 2-butyl-2-ethyl-1,3-propanediol will result in the following sequence, wherein the R group between the indicated urethane functionality may be aromatic, aliphatic or cycloaliphatic:

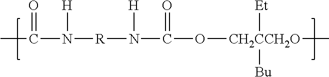

In addition, the reaction of the above referenced diisocyanate with the silicone with two hydroxyl groups that are bonded through an intermediate Si—C linkage to alkylene or alkyleneoxy groups will provide for the following repeat unit, which may also be one of the possible sequences in the polyurethane:

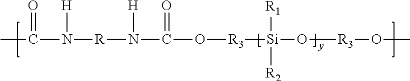

In the above, R₁ and R₂ are methyl groups and R₃ is an alkylene group, and is preferably an alkylene unit comprising —(CH₂)x- repeating functionality, or alkyleneoxy functionality —R₃—OR₃—OH, wherein x may have a value of 2-4, and preferably a —(CH₂)₃— type group. The value of y may fall in the range of 10 to 70 typically 15 to 50.

In one possible case, a repeating unit may therefore have the following structure

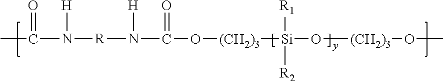

Accordingly, the polyurethane herein may contain both of the above referenced polymeric repeating units. Amongst the possible types of polyurethane repeating unit structures, the following structure may be present, where the variables of R, R₁, R₂ and R₃ are as written above, and the value of y is as written above:

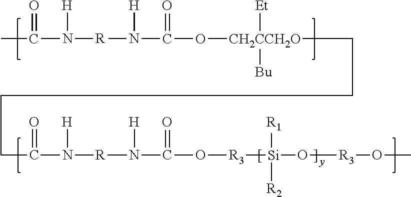

Polyurethanes in general are insoluble in hydrocarbon solvents but soluble either in polar solvents, such as amides, ketones and esters, or water if they contain sufficient proportion of carboxyl groups. Polar solvents are more expensive than hydrocarbon solvent and they are difficult to recover. Hydrocarbon solvents are less expensive and they are easy to recover after evaporating in an oven.

The polyurethane formed herein is one that is a solvent-soluble polyurethane with particular advantage as a release agent suitable for adhesive tapes and advantageously indicates one or more of the following characteristics:
it may be specifically dissolved and transported in toluene solution, stored in toluene solution and coated from a toluene solution without the necessity of heating and maintaining such solution at a temperature above 25° C. for application as a release agent for adhesive tape;
as a release agent that is delivered to the tape manufacturer, the polyurethane is already dissolved thus replacing the dissolving process required for PVODC with simple dilution, which may then reduce or completely eliminates labor, heat, mechanical energy, reduces VOC emission, workers exposure to solvent, fire hazard and dusting. Furthermore, the dilution process is relatively simple, relatively fast and may be automated thus yielding more consistent release;
the process of synthesis and the polyurethanes formed herein can minimize or avoid the risk of release agent precipitation from solution, which would clog the coating head, thereby causing low coat weight and uneven, spotty coating, which can cause costly coater downtime for cleaning, and tape waste;
the lack of heating requirement on coating may also serve to decrease energy demands, solvent emission, workers exposure to hazardous solvent, and fire hazard;
unlike other polyurethane release agents that are practically insoluble in toluene, and PVODC that dissolves in toluene only in relatively low concentrations such as 0.5% by weight at 25° C., the polyurethane release agent herein disclosed dissolves in toluene at relatively high concentrations, which is preferred for coating relatively uneven and high porosity backings, such as latex-impregnated paper that is used in specialty tapes, such as steam sterilizing paper tape, rendering it resistant to high humidity; and
the release agent herein can be used in existing coating lines with existing solvent recovery units with no modification.

It is now noted that the reaction of isocyanate with the hydroxyl-containing chemicals of this invention, such as reaction with BEPD or the identified silicone compound containing hydroxyl functionality, produces urethane or carbamate bonds. For simplicity the reaction products are hereon may be referred to as urethane oligomer or polyurethane.

The product of this invention can be prepared in the melt without solvent and then dissolved in an organic solvent (toluene) in a second step. However, it is preferably prepared in a solvent, preferably a hydrocarbon solvent, such as toluene and/or xylene. Polar solvents may also be used, such as methylbutyl ketone or dimethyl carbonate. The total solids concentration of the reaction product dissolved in a solvent can be as high as 50%, usually about 40% without excessive viscosity build-up that could be difficult to handle. A small amount of a lower alcohol may be mixed into the dissolved polymer to reduce the viscosity. For example, one may mix in up to 15% by weight of methanol, ethanol or propanol. Higher alcohols, such as pentanol, may be present at levels of up to 20% by weight.

The reaction of the composition of this invention yields a polymeric or oligomeric reaction product, depending on the functionality of the silicone (e.g. one or two hydroxyl groups), its molecular weight, and the stoichiometric ratio of the diisocyanate with the sum the hydroxyl groups of the hydroxyl group-bearing compounds. Reference to the sum of the hydroxyl group bearing compounds is reference to the silicon compound (which may provide one or two hydroxyl groups) and the alkyl substituted diol.

The weight average molecular weight (Mw) of the reaction product may preferably be in the range 3,000-50,000. Reference to oligomeric polyurethane molecular weights may be understood herein as falling in the range of Mw value of 3,000-10,000. Reference to polymeric reaction products may be understood herein as reference to Mw values of greater than 10,000 to 50,000. Accordingly, reference to a polyurethane herein should be understood to include both oligomeric and polymeric type reaction products, unless otherwise indicated.

As alluded to above, identifying the diisocyanate monomer as compound “A”, and the silicon compound monomer as compound “B” and the diol monomer as compound “C”, it is recognized that the reaction product herein may comprise a mixture of species comprising various combinations and permutations of these monomers, such as BACACABAC, BACACAB, CABABAC and CACAB.

The silicone segment in the polyurethane of this invention is preferably introduced into the molecule by a compound having a number of dimethylsiloxane segment units, and one or two hydroxyl groups. The hydroxyl groups in the silicone are bonded through intermediate Si—C linkage to alkylene or alkyleneoxy groups. Preferred groups are alkylene, such as propylene and isobutylene. Preferred alkyleneoxy units are ethyleneoxy and/or propyleneoxy. Unlike the Si—O—C linkage, the Si—C bond provides improved hydrolytic stability. The dimethylsiloxane segment may be part of the main polyurethane chain. The number of dimethylsiloxane units per reactant molecule is preferably 15-50 in most cases, but may be as many 70. The hydroxyl groups are preferably placed either at the end of the molecule. The proportion of the silicone compound in the polyurethane formed herein is preferably 10-50% by weight and more preferably 20-35% by weight.

The diisocyanates that can be used in the practice of the invention, in general, include aromatic, aliphatic and cycloaliphatic diisocyanates. In addition, mixtures of two or more species, kinds and types of the isocyanate functional component can be employed. That is, one may mix an aromatic diisocyanate with an aliphatic diisocyanate, or a cycloaliphatic diisocyanate with an aromatic diisocyanate, etc., in the course or preparing the polyurethane polymer.

Preferred examples of diisocyanates that can be employed in the instant invention include both aromatic diisocyanates and/or aliphatic diisocyanates. Toluene diisocyanate (TDI) may preferably be sourced from toluene-2,4-diisocyanate, an 80/20 mixture of toluene-2,4- and toluene-2,6-diisocyanate. Other isocyanates include metaphenylenediisocyanate, methylene-bis-2,4- and 2,6-phenylisocyanate (MDI), hydrogenated MDI, isophorone diisocyanate, tetramethyl-m-xylylene diisocyanate and polymeric MDI's, which are mixtures of di- and triisocyanates based on MDI. They typically contain 8 to 20 carbon atoms or more.

As the reactions with isocyanates are exothermic, it may be only necessary to mix the various components together and allow the temperature to rise to the exotherm temperature and further adjusting the temperature with or without external heating or cooling. The reaction is preferably conducted under anhydrous conditions for such a time at the selected temperature that is practical to provide the desired results. The preferred reaction temperature range is 60-100° C.

The quantity of organic diisocyanates used to prepare the polyurethane is dependent upon the total number of active hydrogen groups available for reaction in both the diol and silicone compound, the particular isocyanate compound used, the molecular weight of the isocyanate, the isocyanate (NCO)/isocyanate-active hydrogen group ratio, etc. All of these factors, while influencing the amount of diisocyanate to be used are easily taken into account by one skilled in the art to determine the precise amount of NCO groups required in any particular formulation.

A typical way to prepare the polyurethane release agent is to first react the diisocyanate with the diol with an excess of isocyanate, and then further react the reactive hydroxyl groups available in the silicone compound while the isocyanate is still in excess, and cap the remainder isocyanate with a stoichiometric amount, or slight excess, of diol.

If desired, catalysts that are normally used to accelerate the NCO reaction can be employed in the instant invention. The use of a catalyst is particularly useful to accelerate the reaction of aliphatic isocyanates. Catalysts include tertiary amines such as triethylamine, tributylamine, N-methylmorpholine, and organometallic compounds such stannous octoate, dibutyl tin dilaurate, zinc octoate.

Optionally, the polyurethane release agent of this invention may be crosslinked on coating. This is normally not necessary. It may sometime be desirable if increased heat and solvent resistance are desirable for some application. Such crosslinking may be preferably achieved by utilizing heat and an excess of the diisocyanate so that it may react with the hydrogen in the urethane linkage, or by use of a triisocyanate.

The release agent of this invention can preferably be used alone or mixed with toluene-soluble polymeric film formers. Such release agent compositions are of particular advantage, as satisfactory release and other functional properties in some instances can be provided much more economically, for example, when the substrate coated is relatively porous as is the case of a paper backing member in the manufacture of pressure-sensitive adhesive tape. The polyurethane release agent herein is preferably present in the release composition at levels of 1.0% to less than 10% by weight. Thus, as the siloxane release agent is the typically the most expensive component of the release compositions, its use therein results in considerable savings. Examples of film formers that may be used in combination with the polyurethane formed herein are polyacrylics, polyvinyl acetate and epoxy resins.

The release agent of this invention can be applied to various substrates, such as plastic film, glass fabric, metal foil, paper and latex impregnated paper by various means. Plastic films are usually coated with a #3-20 Meyer rod, #130-250 rotogravure roll or a series of rotating smooth rolls. Coating with 0.2-1.5% total solids (TS from hereon) solutions yield balanced release properties with film substrate tapes. Paper tapes require higher concentrations of release agent, typically 15-30% and the appropriate coating head.

Release properties develop by simply flashing off toluene in an oven usually at 120-250° F. (50-140° C.), depending on substrate, web speed, oven length, air temperature, air velocity and oven design. Crosslinking is not occurring, nor is it necessary, on drying or tape storage. These properties allow release coating and adhesive coating in a single step. Where the substrate is porous, e.g., papers and textile fabrics, the coating can be applied by such operations as immersion, spraying, brushing, slot and roll coating. Heat, moving air, and their combination may be applied to volatilize toluene and any solvent, if present, thereby leaving a deposit or coating of the release agent or composition on the substrate.

This invention discloses a pressure sensitive adhesive coated article formed by the steps comprising:
a. providing a polyurethane from the reaction product of a mixture of
   A. diisocyanate;
   B. silicon with one or two hydroxyl groups that are bonded through intermediate Si—C linkage to alkylene or alkyleneoxy groups;
   C. diol with alkyl groups wherein the sum of carbon atoms in the alkyl groups bonded to the alpha carbon atoms relative to a hydroxyl group is 5-15;
b. coating a substrate with said polyurethane in toluene solution and removing toluene by heat; and
c. coating said substrate with a pressure sensitive adhesive.

This invention further discloses the process of manufacturing a pressure sensitive adhesive coated substrate comprising the steps of
i. combining:
   A. diisocyanate,
   B. silicone with one or two hydroxyl groups that are bonded through intermediate Si—C linkage to alkylene or alkyleneoxy groups, and
   C. diol with alkyl groups wherein the sum of carbon atoms in the alkyl groups bonded to the alpha carbon atoms relative to a hydroxyl group is 5-15, and forming a polyurethane, in a solvent;
ii. coating a flexible substrate with said polyurethane in toluene and removing toluene by heat, and
iii. coating said substrate with a pressure sensitive adhesive.

In the above process, the polyurethane may initially be formed in an organic solvent, and as noted above, preferably a hydrocarbon solvent, such as toluene and/or xylene. Polar solvents may also be used, such as methylbutyl ketone or dimethyl carbonate. The polyurethane, in toluene, is then utilized to coat the flexible substrate.

Adhesive-coated products herein may include tapes, labels, protective film or paper, printing ink with antiblock, slip, and release properties, and write-on office products such as repositionable note pads. Other applications are, water repellent coating for masonry, concrete, stone, textile, anti-graffiti coating, and metal finishing. Further applications include coating for fibrous containers, rubber, plastic, for the adhesive under linoleum and tile surface and mold release agent.

The pressure-sensitive adhesive composition may comprise in admixture elastomers, a tackifying resins and additives. The elastomer may be styrene-isoprene or styrene-butadiene block or random copolymers, natural rubber or ethylene-vinylacetate rubber. Other generic adhesives may also be used, such as polyacrylates, polyurethanes and vinyl ether polymers. The adhesive is applied to the backing member in the form of a solvent solution, aqueous emulsion or hot-melt by methods of calendering, extrusion, kiss roll coating, etc. The solvent or water is removed from the adhesive composition by evaporation by heating. The adhesive product is then generally wound on itself for storage and for slitting into rolls or sheeted out into suitable width and length. The coverage of pressure-sensitive adhesive composition (on a dry basis) is preferred to be in the range of between about 10-100 g/sqm but may be outside this range if required for specific purposes.

The invention will now be further illustrated and described by reference to the following specific non-limiting Examples.

### Example 1

Toluene 3800 g, BEPD 1076 g and TDI 2122 g were charged in a 5 gal resin kettle. The temperature was maintained at 85° C. for 2.5 hours and the % NCO decreased to 6.54. S-di-25, a linear dimethylsiloxane oligomer having 25 dimethyl siloxane groups and di-omega —(CH₂)₃OH groups, 980 g and toluene, 2500 g was mixed in and further reacted for 2 hours until the NCO decreased to 3.89%. More BEPD, 724 g and toluene, 2100 g were added until the NCO decreased to 0.2% in 10 hours at 70° C. The viscosity was 2500 cps, which was reduced to 600 cps by the addition of isopropanol, 800.

The reaction produced a clear solution, 14079 g with total solids of 34.7% and viscosity of 410 cps. A small portion of the dissolved release agent, isolated from the solution by evaporation of the solvent, had 85-92° C. softening temperature. The solution was diluted down to 2% total solids with toluene, which formed a clear solution.

The release agent was then evaluated as follows: a biaxially oriented polypropylene (BOPP) film, 30 micron thick, was corona treated on both sides to yield surfaces of 42 dynes/cm surface tension. One side of the film was then coated with the 2% total solids toluene solution using a #6 Meyer rod and dried in an oven at 65° C. for 5 minutes. The release-coated film was than laminated with a commercially available pressure sensitive adhesive film tape wherein the adhesive's main components were natural rubber and tackifyers. The laminate was submitted to accelerated aging at 55° C. for 7 days. The tape at 5 cm width was then peeled from the film at a T-peel mode at a speed of 25 cm/min. The force required to peel was 320 g. The peeled tape was then laminated to a finely polished flat stainless steel plate, peeled at 180° angle to yield a peel force of 1840 g. Comparison “Control” test specimen were made up similarly by laminating the adhesive side of the tape to the release agent side, and aging and testing as above. The release and adhesion to steel values for the Control specimen were 1300 g and 1860 g.

### Example 2

The ingredient quantities in this Example 2 are expressed in pounds. Xylene 782, BEPD 43 and TDI, 254, quantities in pound, were charged in a 250 gal stainless steel reactor and the liquid mixture was blanketed with nitrogen. The temperature was raised to 80° C. by external heating and by the exotherm of the reaction and maintained at that temperature for half hour by successive heating and cooling. This procedure was repeated twice more with addition, each time, of BEPD, 43 following by mixing in S-di-25. The mixture was allowed to react for 2 hours. The measured NCO decreased to 3.15%. Further addition of BEPD, 99 and xylene, 203 was followed by maintaining the temperature at 85° C. for 6 hours at which point the measured NCO decreased to 0.15% and resulting in a clear liquid with 5000 cps viscosity. Further addition of isobutyl alcohol, 200 resulted in total solids of 39% and viscosity of 150 cps.

The solid isolated from the solution by evaporation of the solvent had 87-96° C. softening temperature. The solution was diluted down to 2% total solids with toluene, which formed a clear solution.

The release agent was evaluated as in Example 1 but using a premium packaging tape with BOPP backing and the adhesive containing a styrene-isoprene-styrene block copolymer and tackifyer. The results were as follows:

Test specimen, release: 390 g, Control: 1500 g

Test specimen, readhesion to steel: 3200 g, Control: 3200 g

### Example 3

Toluene 782 g, EPHD 45 g and TDI, 254 g were charged in a laboratory size glass reactor and the liquid mixture was blanketed with nitrogen. The temperature was raised to 80° C. by external heating and by the exotherm of the reaction, and maintained at that temperature for half hour by successive heating and cooling. This procedure was repeated twice more with addition, each time, of EPHD, 45 g following by mixing in S-mono-25 that is similar in composition to the silicone of Example 1 except it is monofunctional, it has only 1 hydroxyl group per molecule. The mixture was allowed to react for 2 hours. Further addition of EPHD, 100 g and toluene, 203 g was followed by maintaining the temperature at 85° C. for 6 hours at which point the measured NCO decreased to 0.1% and resulting in a clear liquid with 3500 cps viscosity. Further addition of isobutyl alcohol, 200 g resulted in total solids of 40% and viscosity of 80 cps.

The solid isolated from the solution by evaporation of the solvent had 87-96° C. softening temperature. The solution was diluted down to 2% total solids with toluene, which formed a clear solution.

The release agent was evaluated as in Example 1 but using a premium packaging tape with BOPP backing and the adhesive containing a styrene-isoprene-styrene block copolymer and tackifyers. The results were as follows:

Test specimen, release: 380 g, Control: 1450 g Test specimen, readhesion to steel: 3200 g, Control: 3200 g

### Example 4

The release agent of Example 2 was evaluated similarly to the previous examples but using a crepe paper backing saturated with SBR frequently used for masking application and coating it with a solution of the Example 2 release agent at 20% total solids. The commercial tape used for laminating the release side of the paper was a crepe paper backed commercial adhesive tape having a tacky adhesive containing styrene-isoprene-styrene block copolymer and tackifyers. The results were as follows:

Test specimen, release: 520 g, Control: 1600 g

Test specimen, readhesion to steel: 2800 g, Control: 2700 g

### Example 5

A release agent was prepared similarly to the one prepared in Example 1 except the silicone was S-1-50 which is a linear dimethylsiloxane oligomer having 50 dimethyl siloxane groups and one —(CH₂)₂—O—CH₂CH₂—OH. The total solids of the final solution was 38.0% and viscosity 92 cps after the addition of a minor quantity of the viscosity reducing isopropyl alcohol. The release properties were tested as in Example 1 with the following results:

Test specimen, release: 390 g, Control: 1400 g

Test specimen, readhesion to steel: 1800 g, Control: 1860 g

1. A pressure sensitive adhesive coated article formed by the steps comprising:
a. providing a polyurethane from the reaction product of a mixture of
A. diisocyanate;
B. silicon with one or two hydroxyl groups that are bonded through intermediate Si—C linkage to alkylene or alkyleneoxy groups;
C. diol with alkyl groups wherein the sum of carbon atoms in the alkyl groups bonded to the alpha carbon atoms relative to a hydroxyl group is 5-15;
b. coating a substrate with said polyurethane in toluene solution and removing toluene by heat; and
c. coating said substrate with a pressure sensitive adhesive.

2. The coated article of claim 1 wherein said alkylene group is (CH₂)₃.

3. The coated article of claim 1 wherein said alkyleneoxy group comprises an ethyleneoxy or propyleneoxy group.

4. The coated article of claim 1 wherein said silicon has one hydroxyl group.

5. The coated article of claim 1 wherein sum of the carbon atoms of the alkyl groups is 6-9.

6. The coated article of claim 1 wherein said diol is 2-butyl-2-ethyl-1,3-propanediol.

7. The coated article of claim 1 wherein said diol is 2-ethyl-2-propyl-1,3-hexanediol.

8. The coated article of claim 1 wherein said diisocyanate is selected from selected from the group consisting of toluene-2,4-diisocyanate, an 80/20 mixture of toluene-2,4- and toluene-2,6-diisocyanate, methylene-bis-2,4-phenylisocyanate (MDI), hydrogenated MDI, isophorone diisocyanate, and hexamethylene isocyanate.

9. The coated article of claim 1 wherein said polyurethane has a weight average molecular weight (Mw) of 3,000 to 50,000.

10. The coated article of claim 1 wherein said polyurethane has a weight average molecular weight of 3,000 to 10,000.

11. The coated article of claim 1 wherein said article is a tape or label.

12. A process of manufacturing a pressure sensitive adhesive coated substrate comprising the steps of
i. combining:
A. diisocyanate;
B. silicone with one or two hydroxyl groups that are bonded through intermediate Si—C linkage to alkylene or alkyleneoxy groups;
C. diol with alkyl groups wherein the sum of carbon atoms in the alkyl groups bonded to the alpha carbon atoms relative to a hydroxyl group is 5-15, and forming a polyurethane, wherein said polyurethane is formed in a solvent;
ii. coating a flexible substrate with said polyurethane in toluene and removing toluene by heat; and
iii. coating said substrate with a pressure sensitive adhesive.

13. The process of claim 12 wherein said alkylene group is (CH₂)₃.

14. The process of claim 12 wherein said alkyleneoxy group comprises an ethyleneoxy or propyleneoxy group.

15. The process of claim 12 wherein said silicon has two hydroxyl groups.

16. The process of claim 12 wherein the sum of the carbon atoms in the alkyl groups is 6-9.

17. The process of claim 12 wherein said alkyl substituted diol is 2-butyl-2-ethyl-1,3-propanediol.

18. The process of claim 12 wherein said alkyl substituted diol is 2-ethyl-2-propyl-1,3-hexanediol.

19. The process of claim 12 wherein said diisocyanate is selected from selected from the group consisting of toluene-2,4-diisocyanate, an 80/20 mixture of toluene-2,4- and toluene-2,6-diisocyanate, methylene-bis-2,4-phenylisocyanate (MDI), hydrogenated MDI, isophorone diisocyanate, and hexamethylene isocyanate.

20. The process of claim 12 wherein said polyurethane has a weight average molecular weight (Mw) of 3,000 to 50,000.

21. The coated article of claim 12 wherein said polyurethane has a weight average molecular weight of 3,000 to 10,000

22. The process of claim 12 wherein said article is a tape or label
